(19) United States
(12) Patent Application Publication
(10) Pub. No.: US 2025/0319856 A1
(43) Pub. Date: Oct. 16, 2025

(54) ACTUATION DEVICE FOR A BRAKE SYSTEM

(71) Applicant: Robert Bosch GmbH, Stuttgart (DE)

(72) Inventors: Ben Ferguson, Rettenberg (DE); Guenter Escher, Oberstdorf (DE); Janos Tamas Csoti, Steinheim An Der Murr (DE); Mark Boehm, Lehrensteinsfeld (DE)

(21) Appl. No.: 18/866,302

(22) PCT Filed: May 17, 2023
(86) PCT No.: PCT/EP2023/063299

§ 371 Date: Nov. 15, 2024

(30) Foreign Application Priority Data
May 30, 2022 (DE) 10 2022 205 410.5

(51) Int. Cl. B60T 13/74; F16H 25/24

(52) U.S. Cl. CPC B60T 13/745; F16H 25/2454

(57) ABSTRACT

An actuation device for a brake system. The actuation device includes: an electric machine, wherein a rotor of the electric machine is arranged on a rotatably mounted drive shaft in a rotationally fixed manner; a displaceably mounted pressure element; and a transmission device, using which the drive shaft is operatively connected to the pressure element, wherein the transmission device has a displaceable threaded spindle, wherein a rotation-locking element is rotationally fixed to the threaded spindle, and wherein the rotation-locking element interacts with a housing of the actuation device and/or with an element of the actuation device that is arranged on the housing in a fixed manner, in order to form an anti-rotation device for the threaded spindle. The rotationally-fixed connection between the rotation-locking element and the threaded spindle is formed by a form-fitting connection.

### FIELD

The present invention relates to an actuation device for a brake system, including: an electric machine, wherein a rotor of the electric machine is arranged on a rotatably mounted drive shaft in a rotationally fixed manner; a displaceably mounted pressure element; and a transmission device, by means of which the drive shaft is operatively connected to the pressure element, wherein the transmission device has a displaceable threaded spindle, wherein a rotation-locking element is rotationally fixed to the threaded spindle, and wherein the rotation-locking element interacts with a housing of the actuation device and/or with an element of the actuation device that is arranged on the housing in a fixed manner, in order to form an anti-rotation device for the threaded spindle.

The present invention also relates to a brake system.

### BACKGROUND INFORMATION

A hydraulic brake system of a motor vehicle typically comprises a plurality of friction brake devices. The friction brake devices are operatively connected to an actuation device of the brake system in such a way that the friction brake devices can be actuated by the actuation device. With the increasing electrification of motor vehicles, actuation devices of brake systems are also becoming increasingly electrified. In this regard, it is conventional to equip an actuation device for a brake system with an electric machine, wherein a rotor of the electric machine is arranged on a rotatably mounted drive shaft in a rotationally fixed manner. In order to make it possible for the friction brake devices to be actuated by the actuation device, the actuation device also has a displaceably mounted pressure element. The drive shaft is operatively connected to the pressure element by means of a transmission device. The transmission device is thus designed to convert a rotation of the drive shaft into a translational movement of the pressure element. For this purpose, the transmission device often has a displaceable threaded spindle. In order to prevent rotation of the threaded spindle during operation of the actuation device, a rotation-locking element is generally rotationally fixed to the threaded spindle. The rotation-locking element interacts with a housing of the actuation device and/or with an element of the actuation device that is arranged on the housing in a fixed manner, in order to form an anti-rotation device for the threaded spindle. In conventional actuation devices, the rotation-locking element is typically welded to the threaded spindle so that the rotationally fixed connection between the rotation-locking element and the threaded spindle is formed by an integral bond.

### SUMMARY

An actuation device according to the present invention may have the advantage that the actuation device can be realized cost-effectively. According to an example embodiment of the present invention, it is provided for this purpose that the rotationally fixed connection between the rotation-locking element and the threaded spindle is formed by a form-fitting connection. When assembling the actuation device, the form-fitting connection is easier to form than the aforementioned integral bond, meaning that the assembly effort is reduced. This can reduce the production costs for the actuation device. In addition, the assembly of the actuation device is also facilitated in that it is not necessary for the threaded spindle and the rotation-locking element to be spatially accessible to a welding device. In particular, the rotationally fixed connection between the rotation-locking element and the threaded spindle is formed simply by plugging the two elements together. Preferably, the rotation-locking element is arranged on the threaded spindle in a rotationally fixed manner. According to a preferred embodiment, the transmission device comprises a spindle transmission, wherein the spindle transmission comprises the threaded spindle. According to an alternative embodiment, the transmission device preferably comprises a ball screw drive, wherein the ball screw drive comprises the threaded spindle. Preferably, the threaded spindle is coupled to the pressure element in such a way that the pressure element can be displaced by the threaded spindle. Alternatively, the threaded spindle preferably forms the pressure element.

According to a preferred example embodiment of the present invention, it is provided that the form-fitting connection is formed by at least one radially protruding driver element. Such a driver element can be used to realize a mechanically robust form-fitting connection. The driver element protrudes, for example, radially inward or radially outward. Preferably, the threaded spindle and the rotation-locking element each have at least one radially protruding driver element, wherein the driver elements interact to form the anti-rotation device.

According to a preferred example embodiment of the present invention, it is provided that a driver toothing of the rotation-locking element meshes with a driver toothing of the threaded spindle in order to form the form-fitting connection. A driver toothing has a plurality of tooth-shaped driver elements arranged one behind the other in the circumferential direction. The driver teeth make it possible for a mechanically particularly robust form-fitting connection to be realized. In particular, it is achieved that torques transmitted from the threaded spindle to the rotation-locking element during operation of the actuation device act on the rotation-locking element in a uniformly distributed manner in the circumferential direction of the rotation-locking element.

According to a preferred example embodiment of the present invention, it is provided that the rotation-locking element is made of plastic. By manufacturing the rotation-locking element from plastic, even complex geometries such as the driver element or the driver toothing can be produced easily. In particular, the rotation-locking element is made of plastic by means of an injection molding process. Particularly preferably, the rotation-locking element is made of glass fiber reinforced plastic. This material has a high level of strength, meaning that the rotation-locking element can be designed to be comparatively small or slim. This saves material costs and installation space.

Preferably, the rotation-locking element is made of a metal material. A metal material also has a high level of strength, meaning that the rotation-locking element can be designed to be comparatively small in order to save material costs and installation space. Particularly preferably, the rotation-locking element is made of steel. Preferably, the rotation-locking element is made of a metal material by means of a cold forming process, for example by cold forging.

According to a preferred example embodiment of the present invention, it is provided that the rotation-locking element is designed to be skeletonized by means of recesses. In particular, when manufacturing the rotation-locking element from glass fiber reinforced plastic or from a metal material, a solid design of the rotation-locking element is not necessary with regard to sufficient mechanical strength. By providing the recesses, the material costs can therefore be further reduced.

Preferably, the threaded spindle is manufactured by a cold forming process. By means of a cold forming process, the necessary structural elements of the threaded spindle, such as a screw thread of the threaded spindle or the driver element or the driver toothing, can be manufactured in the same process without subsequent machining steps. This has the result that the production costs of the threaded spindle can be reduced. Alternatively, the threaded spindle is only partially manufactured by a cold forming process. For example, a blank for the threaded spindle is first manufactured by a cold forming process. The screw thread and/or the driver element or the driver toothing are subsequently formed by a machining process, such as shaping or rolling.

According to a preferred example embodiment of the present invention, it is provided that the rotation-locking element is axially fixed to the threaded spindle, in relation to the displacement axis of the threaded spindle. This makes fastening the rotation-locking element to the threaded spindle mechanically particularly robust, and the threaded spindle can be easily handled together with the rotation-locking element as a subassembly, for example when assembling the actuation device. According to an alternative embodiment, it is preferably provided that the rotation-locking element has axial play relative to the threaded spindle.

According to a preferred example embodiment of the present invention, it is provided that the threaded spindle or the rotation-locking element has an undercut or undercutting, in which the rotation-locking element or the threaded spindle engages in order to axially fix the rotation-locking element to the threaded spindle. The in particular radial engagement of the rotation-locking element or of the threaded spindle in the undercut or undercutting creates a mechanically robust, axially fixed connection between the rotation-locking element and the threaded spindle. Preferably, the undercut or undercutting extends in the circumferential direction completely through the threaded spindle or through the rotation-locking element. Such an undercut or undercutting is technically easy to realize.

According to a preferred example embodiment of the present invention, it is provided that the rotation-locking element is axially fixed to the threaded spindle by press-fitting the rotation-locking element and/or by press-fitting the threaded spindle. The rotation-locking element and/or the threaded spindle are thus reshaped by press-fitting in order to axially fix the rotation-locking element to the threaded spindle. This makes it possible to realize a mechanically particularly robust force-fitting and/or form-fitting connection. Preferably, the rotation-locking element is reshaped by press-fitting in such a way that it engages in the undercut or undercutting of the threaded spindle, in particular radially. Alternatively or additionally, the threaded spindle is preferably reshaped by press-fitting in such a way that it engages in the undercut or undercutting of the rotation-locking element, in particular radially.

According to a preferred example embodiment of the present invention, it is provided that the threaded spindle has a first end portion facing the pressure element, and that the rotation-locking element is arranged on the first end portion. The first end portion is easily accessible for the arrangement of the rotation-locking element, and so the arrangement on the first end portion is preferred. Arranging the rotation-locking element on the first end portion also has the advantage that the position of the first end portion in the radial direction is particularly precisely defined, which is advantageous for a reliable transmission of axial forces from the threaded spindle to the pressure element.

According to a preferred example embodiment of the present invention, it is provided that the rotation-locking element has an annular portion, and that the threaded spindle is inserted into an opening in the annular portion. In this way, the form-fitting connection between the rotation-locking element and the threaded spindle can be advantageously realized. Preferably, an inner casing surface of the rotation-locking element that forms the opening has the driver toothing of the rotation-locking element for this purpose. Preferably, an outer casing surface of the threaded spindle that is radially opposite the inner casing surface has the driver toothing of the threaded spindle. Preferably, at least one of the aforementioned recesses is formed in the annular portion. Particularly preferably, the annular portion has at least one annular recess and/or at least one annular-portion-shaped recess.

Preferably, the rotation-locking element has at least one radial protrusion, which radially engages in a radial depression in the housing of the actuation device in order to form the anti-rotation device. The rotation-locking element thus interacts with the housing of the actuation device in order to form the anti-rotation device. This forms a particularly reliable anti-rotation device. Preferably, the rotation-locking element has a plurality of radial protrusions, which each radially engage in a different radial depression in the housing in order to form the anti-rotation device. Particularly preferably, the rotation-locking element has two radial protrusions, which are arranged at an offset of 180° in the circumferential direction of the rotation-locking element. Preferably, at least one of the aforementioned recesses is formed in the radial protrusion. Particularly preferably, the radial protrusion has one or more prism-shaped recesses.

Preferably, a sliding shoe is arranged on the radial protrusion. The sliding shoe ensures low-friction guidance of the radial protrusion in the radial depression.

Preferably, the housing is a cylindrical extrusion profile. Extrusion profiles are typically cost-effective to produce, and therefore the production costs for the actuation device are further reduced by designing the housing as an extrusion profile. A cylindrical element has a casing wall that is at least substantially closed in the circumferential direction, wherein the casing wall forms or encloses an axial opening in the cylindrical element. Accordingly, the cylindrical extrusion profile also has such a casing wall and such an axial opening, wherein the axial opening forms a housing interior of the extrusion profile. However, the term “cylindrical” does not imply a cross-section of a specific shape. Rather, the cross-section of the extrusion profile can have different shapes. Preferably, however, the axial opening has an at least substantially circular cross-section. Preferably, the extrusion profile is made of aluminum. The design of the housing as an extrusion profile also offers the advantage that the aforementioned radial depression, in which the radial protrusion of the rotation-locking element engages radially, can be realized without additional processing steps.

The present invention is explained in more detail below with reference to the figures.

### BRIEF DESCRIPTION OF THE DRAWINGS

FIG. 1 is a sectional view of an actuation device for a brake system, according to an example embodiment of the present invention.

FIG. 2 is a further sectional view of the actuation device, according to an example embodiment of the present invention.

FIG. 3 is a sectional view of a transmission device of the actuation device, according to an example embodiment of the present invention.

FIG. 4 is a plan view of a rotation-locking element of the actuation device, according to an example embodiment of the present invention.

### DETAILED DESCRIPTION OF EXAMPLE EMBODIMENTS

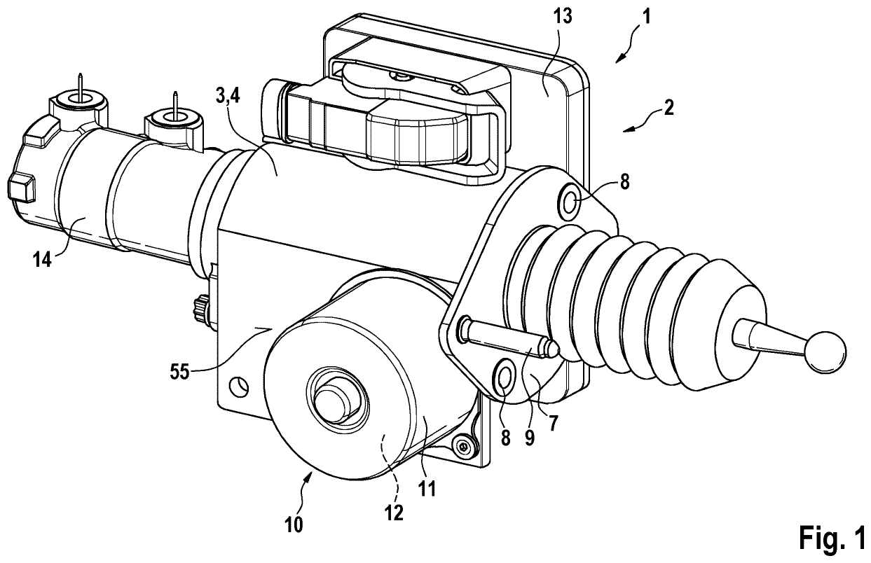

FIG. 1 shows a longitudinal section through an actuation device 1 for a brake system 2 (not shown in detail) of a motor vehicle. The actuation device 1 has a displaceably mounted pressure element 3, which in the present case is designed as a pressure rod 3. The pressure element 3 is displaceable along a displacement axis 4 in a first direction 5 and in a second direction 6 opposite the first direction 5. The displacement axis 4 corresponds to the longitudinal center axis of the pressure element 3.

The pressure element 3 is at least partially arranged in a housing 7 of the actuation device 1. In the present case, the housing 7 is a cylindrical extrusion profile 7. In this respect, the housing 7 has a circumferentially closed casing wall 8. The casing wall 8 forms or encloses an axial opening 9 in the housing 7, wherein the axial opening 9 forms a housing interior 10 of the housing 7. In the present case, the axial opening 9 has a circular cross-section. The pressure element 3 is arranged in the housing 7 or the housing interior 10 in such a way that the displacement axis 4 is aligned perpendicularly to a cross-sectional area of the housing 7.

A master brake cylinder 11 of the actuation device 1 is arranged on the housing 7 in a fixed manner. In the present case, the master brake cylinder 11 is arranged on a first end face 12 of the casing wall 8. In the master brake cylinder 11, a first hydraulic piston 13 and a second hydraulic piston 14 are mounted displaceably, namely in the first direction 5 and in the second direction 6. The master brake cylinder 11 has a plurality of hydraulic connections 15, 16. If the actuation device 1 is installed in the brake system 2 as intended, the hydraulic connections 15, 16 are fluidically connected to slave cylinders of friction brake devices of the brake system 2. The friction brake devices can in this case be actuated by displacing the hydraulic pistons 13 and 14 in the first direction 5. The pressure element 3 is coupled to the hydraulic pistons 13 and 14 in such a way that the hydraulic pistons 13 and 14 can be displaced in the first direction 5 by the pressure element 3. The friction brake devices can thus be actuated by displacing the pressure element 3.

A housing plate 17 is also arranged on the housing 7 in a fixed manner. In the present case, the housing plate 17 is arranged on a second end face 18 of the casing wall 8 that faces away from the first end face 12. The housing plate 17 closes the axial opening 9 at least partially.

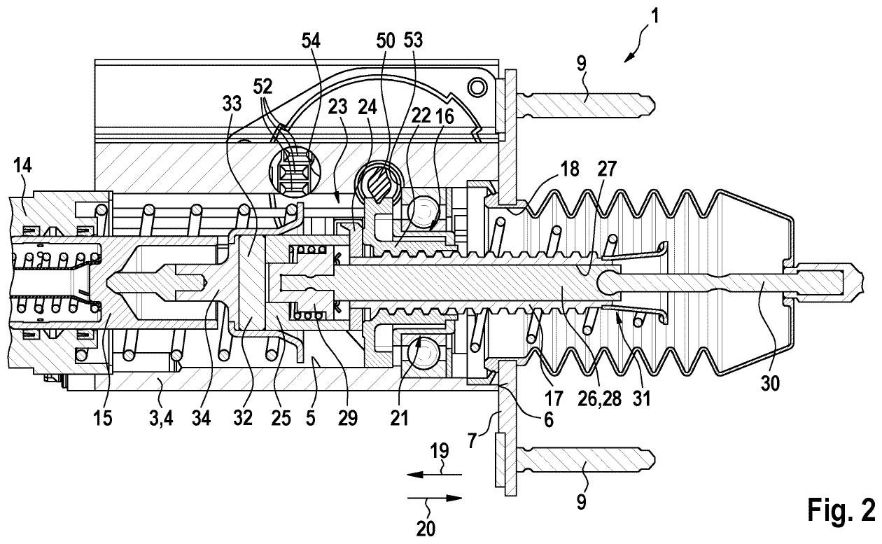

The actuation device 1 also has a drive unit 19. In the following, the design of the drive unit 19 is explained in more detail with reference to FIG. 2. For this purpose, FIG. 2 shows a cross-section through the actuation device 1. The drive unit 19 has a motor housing 20, in which an electric machine 21 is arranged. An annular rotor 22 of the electric machine 21 is arranged on a drive shaft 23 in a rotationally fixed manner, wherein the drive shaft 23 is mounted rotatably about a rotation axis 24. An annular stator 25 of the electric machine 21 is arranged on the motor housing 20 in a fixed manner and radially encloses the rotor 22 in relation to the rotation axis 24. The motor housing 20 is fastened to the housing 7.

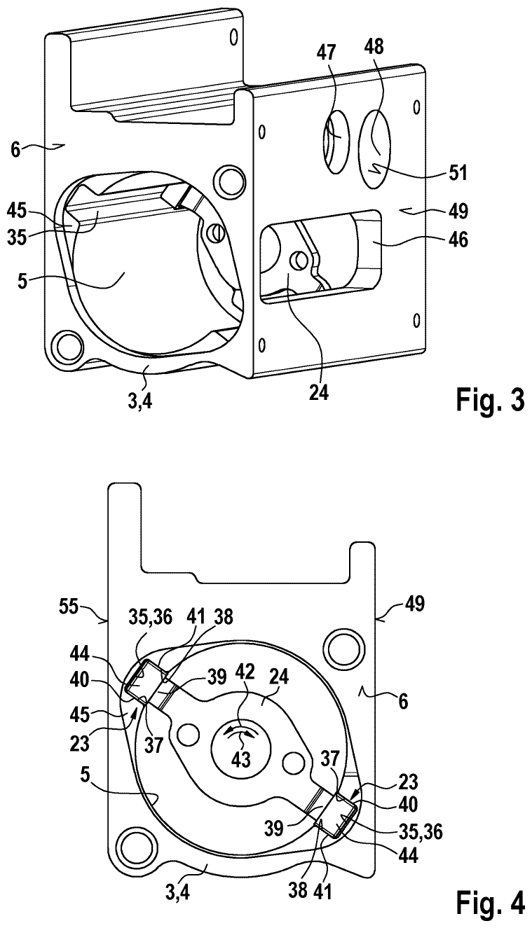

The drive shaft 23 is coupled to the pressure element 3 by a transmission device 26 in such a way that the pressure element 3 can be displaced by the electric machine 21. FIG. 3 is a sectional view of the transmission device 26. The transmission device 26 has a threaded spindle 27, which is displaceable in the first direction 5 and in the second direction 6. The threaded spindle 27 is coupled to the pressure element 3 in such a way that the pressure element 3 can be displaced by the threaded spindle 27 at least in the first direction 5. The threaded spindle 27 has a screw thread 28. The screw thread 28 forms a drive toothing of the threaded spindle 27. The threaded spindle 27 is part of a transmission 29 of the transmission device 26, which is designed to convert a rotation into a translational movement of the threaded spindle 27. In the present case, the transmission 29 is designed as a spindle transmission 29. In addition to the threaded spindle 27, the spindle transmission 29 has a rotatably mounted spindle nut 30. The spindle nut 30 and the threaded spindle 27 are arranged coaxially with one another. An output toothing 60 of the spindle nut 30 meshes with the screw thread 28 of the threaded spindle 27 in such a way that the threaded spindle 28 can be displaced by rotating the spindle nut 30. According to a further exemplary embodiment, the transmission 29 is not designed as a spindle transmission but as a ball screw drive.

According to the exemplary embodiment shown in the figures, the transmission device 26 also has a worm gear 31 with a worm shaft 32 and a worm wheel 33. The worm shaft 32 is formed by the drive shaft 23. In the present case, the worm wheel 33 is arranged on the spindle nut 30 in a rotationally fixed manner. According to a further exemplary embodiment, the spindle nut 30 and the worm wheel 33 are formed in one piece with each other.

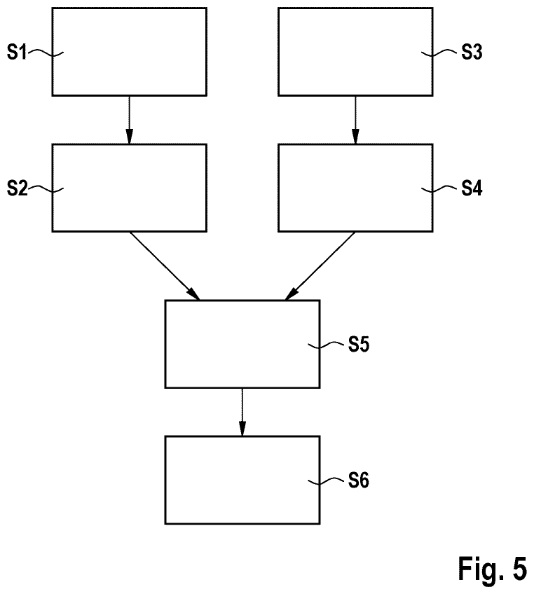

A rotation-locking element 35 is arranged on a first end portion 34 of the threaded spindle 27 that faces or is assigned to the pressure element 3. FIG. 4 shows a plan view of the rotation-locking element 34, wherein the viewing direction corresponds to the second direction 6. The rotation-locking element 35 is connected to the threaded spindle 27 in a rotationally fixed manner. The rotationally fixed connection between the rotation-locking element 35 and the threaded spindle 27 is formed by a form-fitting connection 36.

According to the exemplary embodiment shown in the figures, the rotation-locking element 35 has an annular portion 61 with an opening 37. The threaded spindle 27 is inserted into the opening 37. An inner casing surface 38 of the rotation-locking element 35 that forms or encloses the opening 37 has a first driver toothing 39 with a plurality of tooth-shaped first driver elements 40. The first driver elements 40 protrude radially inward from the inner casing surface 38. An outer casing surface 41 of the threaded spindle 27 that is radially opposite the inner casing surface 38 has a second driver toothing 42 with a plurality of tooth-shaped second driver elements 43. The second driver elements 43 protrude radially outward from the outer casing surface 41. The first driver toothing 39 meshes with the second driver toothing 42 in order to form the form-fitting connection 36.

The rotation-locking element 35 interacts with the housing 7 in order to form an anti-rotation device 44 for the threaded spindle 27. According to a further exemplary embodiment, the rotation-locking element 35 does not interact with the housing 7 but with an element fixed to the housing. In the present case, the rotation-locking element 35 has two radial protrusions 45, which protrude radially outward from the annular portion 61. However, there may also be a different number of radial protrusions 45. In the present case, the radial protrusions 45 are arranged at an offset of 180° in the circumferential direction of the rotation-locking element 35. The radial protrusions 45 each engage radially in a different radial depression 46 in the housing 7 in order to form the anti-rotation device 44. In the present case, a sliding shoe 48 is arranged on each of the radially outer ends 47 of the radial protrusions 45. The sliding shoes 48 ensure low-friction guidance of the radial protrusions 45 in the radial depressions 46.

In the present case, the rotation-locking element 35 is made of a glass fiber reinforced plastic, for example by means of an injection molding process. This material has such a level of strength that a solid design of the rotation-locking element 35 is not necessary. In order to reduce material costs, the rotation-locking element 35 is provided with recesses 49 in such a way that the rotation-locking element 35 is skeletonized. In the present case, the annular portion 61 has two annular-portion-shaped recesses 49a. The radial protrusions 45 each have a plurality of prism-shaped recesses 49b. According to a further exemplary embodiment, the rotation-locking element 35 is preferably made of a metal material, for example by means of a cold forming process. Even if manufactured from the metal material, the rotation-locking element 35 preferably has the recesses 49. The threaded spindle 27 including the screw thread 28 and the second driver toothing 42 is preferably manufactured by a cold forming process.

The rotation-locking element 35 is also axially fixed to the threaded spindle 27. In the present case, the threaded spindle 27 has an undercut 50 for this purpose. The undercut 50 extends in the circumferential direction of the threaded spindle 27 completely along the threaded spindle 27. The rotation-locking element 35 is formed by press-fitting in such a way that the rotation-locking element 35 engages radially in the undercut 50. Alternatively, the rotation-locking element 35 is preferably axially fixed to the threaded spindle 27 by a latching connection. For example, the rotation-locking element 35 has at least one latching protrusion, which engages radially in the undercut 50. According to a further exemplary embodiment, the rotation-locking element 35 has the undercut 50, and the threaded spindle 27 engages radially in the undercut 50 in order to fix the rotation-locking element 35 axially to the threaded spindle 27.

The actuation device 1 also has an actuation element 51, which is displaceably mounted in an axial opening 52 in the threaded spindle 27. A first end 53 of the actuation element 51 is coupled or can be coupled to a brake pedal of the brake system 2 by an input rod 54 so that the actuation element 51 can then be displaced by actuating the brake pedal. A second end 55 of the actuation element 51 is coupled to the pressure element 3 in such a way that the pressure element 3 can be displaced by the actuation element 51. The friction brake devices can thus also be actuated by actuating the brake pedal.

1-15. (canceled)

16. An actuation device for a brake system, comprising:
an electric machine, wherein a rotor of the electric machine is arranged on a rotatably mounted drive shaft in a rotationally fixed manner;
a displaceably mounted pressure element; and
a transmission device, using which the drive shaft is operatively connected to the pressure element, wherein the transmission device has a displaceable threaded spindle;
wherein a rotation-locking element is rotationally fixed to the threaded spindle;
wherein the rotation-locking element interacts with a housing of the actuation device and/or with an element of the actuation device that is arranged on the housing in a fixed manner, to form an anti-rotation device for the threaded spindle; and
wherein a rotationally fixed connection between the rotation-locking element and the threaded spindle is formed by a form-fitting connection.

17. The actuation device according to claim 16, wherein the form-fitting connection is formed by at least one radially protruding driver element.

18. The actuation device according to claim 16, wherein a driver toothing of the rotation-locking element meshes with a driver toothing of the threaded spindle to form the form-fitting connection.

19. The actuation device according to claim 16, wherein the rotation-locking element is made of plastic, the plastic being glass fiber reinforced plastic.

20. The actuation device according to claim 16, wherein the rotation-locking element is made of a metal material using a cold forming process.

21. The actuation device according to claim 16, wherein the rotation-locking element is skeletonized by means of recesses.

22. The actuation device according to claim 16, wherein the threaded spindle is manufactured by a cold forming process.

23. The actuation device according to claim 16, wherein the rotation-locking element is axially fixed to the threaded spindle.

24. The actuation device according to claim 23, wherein the threaded spindle or the rotation-locking element has an undercut, in which the rotation-locking element or the threaded spindle engages in order to axially fix the rotation-locking element to the threaded spindle.

25. The actuation device according to claim 23, wherein the rotation-locking element is axially fixed to the threaded spindle by press-fitting the rotation-locking element and/or by press-fitting the threaded spindle.

26. The actuation device according to claim 16, wherein the threaded spindle has a first end portion facing the pressure element, and the rotation-locking element is arranged on the first end portion.

27. The actuation device according to claim 16, wherein the rotation-locking element has an annular portion, and wherein the threaded spindle is inserted into an opening in the annular portion.

28. The actuation device according to claim 16, wherein the rotation-locking element has at least one radial protrusion, which radially engages in a radial depression in the housing of the actuation device to form the anti-rotation device.

29. The actuation device according to claim 18, wherein a sliding shoe is arranged on the radial projection.

30. The actuation device according to claim 16, wherein the housing is a cylindrical extrusion profile.
